(19) United States
(12) Patent Application Publication
(10) Pub. No.: US 2004/0181957 A1
(43) Pub. Date: Sep. 23, 2004

(54) Nozzle assembly setting gauge and electrode adjuster

(76) Inventor: Nikolay Polkhouskiy, Whites Boro, NY (US)

Correspondence Address: David Giglio, 231 Elizabeth Street, Utica, NY, 13501, US

(21) Appl. No.: 10/390,392

(22) Filed: Mar. 18, 2003

(51) Int. Cl. G01D 21/00

(52) U.S. Cl. 33/652

(57) ABSTRACT

There is provided a nozzle assembly setting gauge that is secured to the nozzle assembly. The nozzle assembly setting gauge further includes a setting post that contacts the combustion head when the nozzle assembly is in the proper reset position. As an added feature the nozzle assembly setting gauge also includes an electrode adjuster that allows a technician to properly gap and position the electrode pair without reference to any manuals or the requirements of any special tools. The electrode adjuster can also be independent of the nozzle assembly setting gauge.

### FIELD OF THE INVENTION

This invention relates generally to the field of oil burners, and more particularly, to the field of maintaining nozzle assemblies in oil burners.

### BACKGROUND OF THE INVENTION

Oil burning appliances often include a nozzle assembly system secured inside of a burner housing and an air tube. Oil flows through the nozzle assembly and is ejected at a nozzle. The ejected oil is burned at a combustion head, wherein the burning is ignited by a pair of electrodes disposed in front of the nozzle.

It is often necessary to remove the nozzle assembly for routine maintenance. It is important that the nozzle be a predetermined distance from the combustion head for efficient burning. In some burners the nozzle assembly is directly connected to the combustion head by a bracket system, or support posts so that the distance between the nozzle and the combustion head remains constant.

In other systems the nozzle assembly is not connected to the combustion head. In these systems it is often times difficult to properly gauge the reset position of the nozzle assembly.

One attempt to overcome this problem was described in U.S. Pat. No. 6,108,923 to Polkhovskiy, the same inventor herein, which is hereby incorporated by reference. Polkhovskiy used a nozzle assembly setting gauge that fit over the nozzle and nozzle adapter. The nozzle assembly would be inserted into the burner housing and air tube until the nozzle assembly setting gauge contacted the combustion head. This inserted position would be marked relative to the burner housing. Then the nozzle assembly is removed so that the nozzle assembly setting gauge could also be removed from the nozzle assembly. Then the nozzle assembly is reinserted into its marked reset position. One problem with this method is that it requires several steps, including the step of marking the burner housing.

If this gauge were left in position over the nozzle, the gauge would interfere with oil burning and ignition.

Another problem encountered in maintaining oil burners is that oftentimes electrodes become displaced during maintenance or partially burn away after prolonged use. It is important that electrode tips be separated by a predetermined gap for proper ignition and also positioned a predetermined distance from the center and front of the nozzle. Usually a technician carries a gauge in his repair and maintenance kit or uses a tape measure to determine the proper gap between electrodes and the proper distance between the electrodes and the center and front of the nozzle. However, different oil burners require different gaps and distances. Therefore, the technician must often refer to a manual, given he can find one, to determine the proper distances between the electrode tips and the proper distance between the electrode tips and the front and center of the nozzle.

### OBJECTS AND SUMMARY OF THE PRESENT INVENTION

It is therefore and object of the present invention to improve the art of oil burners.

It is another object of the present invention to improve the art of maintaining oil burners.

It is yet another object of the present invention to provide a simpler method and apparatus for resetting a nozzle assembly in an oil burner.

It is still another object of the present invention to provide an ever ready method and apparatus for resetting the gap between an electrode pair in an oil burner.

It is still a further object of the present invention to provide an ever ready method and apparatus for resetting the distance between an electrode pair and the front and center of the nozzle.

These and other objects are provided in accordance with the present invention wherein there is provided a nozzle assembly setting gauge that is secured to the nozzle assembly. The nozzle assembly setting gauge includes a setting post that contacts the combustion head when the nozzle assembly is in the proper reset position. As an added feature the nozzle assembly setting gauge also includes an electrode adjuster that allows a technician to properly gap the electrode pair and set the proper distance between the electrode pair and the front and center of the nozzle without reference to any manuals or the requirements of any special tools.

### BRIEF DESCRIPTION OF THE DRAWINGS

The above and other objects of the present invention will be better understood by reading the following detailed description of the preferred embodiments of the invention, when considered in connection with the accompanying drawings, in which:

FIG. 1 is a perspective view of a nozzle assembly setting gauge in accordance with a preferred embodiment of the present invention;

FIG. 2 is a top view of the nozzle assembly setting gauge of FIG. 1;

FIG. 3 is a top view of an oil burner showing nozzle assembly, a combustion head and the nozzle assembly setting gauge of FIG. 1;

FIG. 4 is a perspective view of a nozzle assembly setting gauge of FIG. 1 having an electrode adjuster;

FIG. 5 is a top view of an oil burner of FIG. 3 showing nozzle assembly setting gauge of FIG. 4 in a nozzle assembly adjust position;

FIG. 6 is a top view of nozzle assembly of FIG. 5 showing nozzle assembly setting gauge with an electrode adjuster of FIG. 4 in the electrode adjust position;

FIG. 6A is a side view of the nozzle assembly of FIG. 6 showing the adjustment of the electrode tips relative to the nozzle;

FIG. 7 is a perspective view of an electrode adjuster in accordance with an alternative embodiment of the present invention;

FIG. 8 is a side view of a nozzle assembly that is connected to a combustion head by brackets, wherein the electrode adjuster of FIG. 7 is pivotally mounted to a bracket in a non-adjust position;

FIG. 9 is a side view of the nozzle assembly of FIG. 8, wherein the electrode adjuster is in the adjust position;

FIG. 10 is a top view of the oil burner of FIG. 3 showing a nozzle assembly setting gauge secured to the nozzle assembly line;

FIG. 11 is a top view of the oil burner of FIG. 3 showing a nozzle assembly setting gauge secured to the static plate;

FIG. 12 is a top view of the oil burner of FIG. 3 showing a nozzle assembly setting gauge secured to the nozzle assembly support;

FIG. 13 is a top view of the nozzle assembly in FIG. 3 having a nozzle assembly setting gauge with an electrode adjuster, secured to the nozzle assembly pipe in accordance with yet another embodiment of the present invention;

FIG. 14 is a top view of the nozzle assembly in FIG. 3 having a nozzle assembly setting gauge with an electrode adjuster, secured to the nozzle pipe adapter in accordance with yet another embodiment of the present invention;

FIG. 15 is a top view of the oil burner of FIG. 3, showing a nozzle assembly setting gauge in accordance with still yet another embodiment of the present invention;

FIG. 16 is a perspective view of a nozzle assembly setting gauge with electrode adjuster in accordance with an alternative embodiment of the present invention;

FIG. 17 is a top view of the oil burner of FIG. 3 having the nozzle assembly setting gauge with electrode adjuster of FIG. 16;

FIG. 18 is a side view of the nozzle assembly of FIG. 8 having a slidable electrode adjuster in the adjust position;

FIG. 19 is a side view of the nozzle assembly of FIG. 18 wherein the slidable electrode adjuster is in the non-adjust position;

FIG. 20 is a side view of the nozzle assembly of FIG. 8, wherein a pivotal electrode adjuster is secured to a bracket;

FIG. 21 is a side view of the nozzle assembly of FIG. 3 having a slidable electrode adjuster in the adjust position;

FIG. 22 is a side view of the nozzle assembly of FIG. 21 wherein the slidable electrode adjuster is in the non-adjust position;

FIG. 23 is a perspective view of a slidable electrode adjuster for use with a nozzle assembly being connected by posts to a combustion head;

FIG. 24 is a perspective view of an electrode adjuster having a rotating arm for use with a nozzle assembly being connected by posts to a combustion head;

FIG. 25 is a side view of a nozzle assembly being connected by posts to a combustion head having the electrode adjuster with a rotating arm of FIG. 24 in an adjust position;

FIG. 26 is a side view of the nozzle assembly of FIG. 25 showing the electrode adjuster in a non-adjust position;

FIG. 27 is a side view of the nozzle assembly of FIG. 25 having a slidable electrode adjuster of FIG. 23 in an adjust position;

FIG. 28 is a side view of the nozzle assembly of FIG. 27 wherein the slidable electrode adjuster is in the non-adjust position;

FIG. 29 is a side view of a nozzle assembly having a swing away electrode adjuster in an adjust position;

FIG. 30 is a side view of a nozzle assembly showing the swing away electrode adjuster of FIG. 29 in a non-adjust position;

FIG. 31 is a top view of a nozzle assembly showing a sliding electrode adjuster disposed from the nozzle setting gauge of FIG. 3 in a non-adjust position; and

FIG. 32 is a top view of a nozzle assembly showing the sliding electrode adjuster of FIG. 31 in an adjust position.

### DETAILED DESCRIPTION OF THE PRESENT INVENTION

The present invention will now be described in accordance with the drawings, wherein there are numerous examples. The present invention must not be limited to the specific examples.

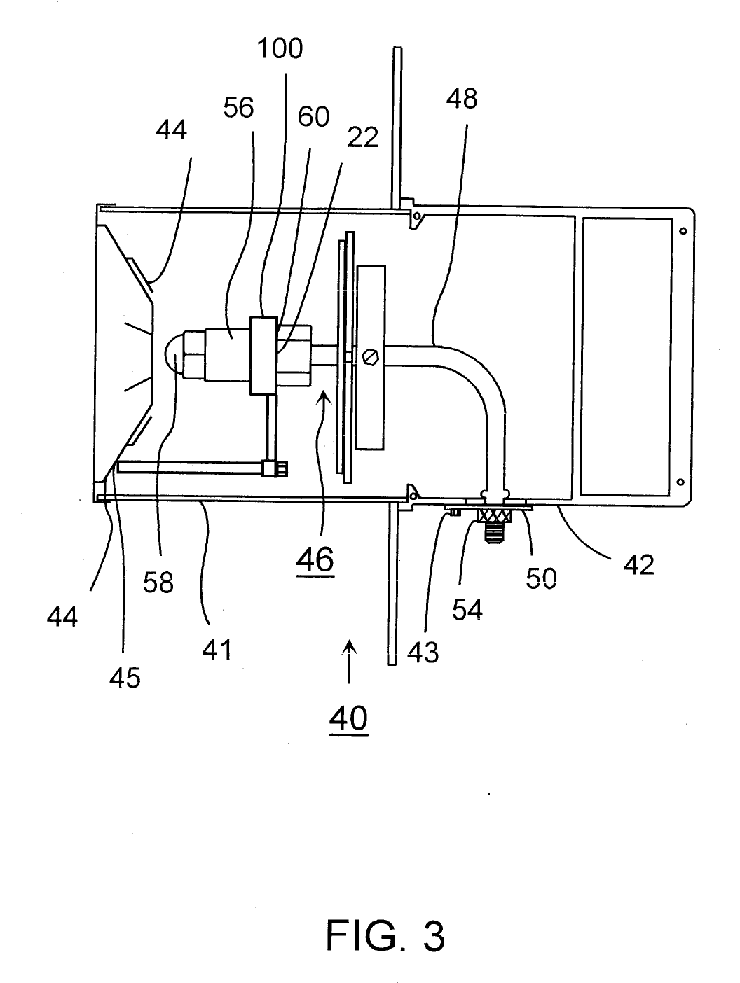

Referring now to FIG. 3, there is shown an oil burner 40 for use in heating systems. A nozzle assembly 46 is secured to a burner housing 42 and extend through an air tube 41 so that oil flows from a source to the nozzle 58 where it is ejected and burned at a combustion head 44. Not shown in FIG. 3 but shown in FIG. 5, there is a pair of electrodes 64 which cause the ignition of the oil.

The nozzle assembly 46 typically includes a nozzle assembly pipe 48, a nozzle adapter 56, a nozzle assembly support 72, a static plate 84, and the nozzle 58. It is important that the nozzle 58 be a predetermined distance from the combustion head 44 for efficient oil burning. It is also important that the electrodes 64 have a predetermined gap between their tips 86 in order to properly ignite the oil. It is also important that the electrodes tips 86 are a predetermined distance from the front and center of the nozzle 58.

The nozzle assembly 46 must often be removed during routine maintenance. Therefore, a technician removes the nozzle assembly 46 by removing a threaded nut 54 that secures the nozzle assembly 46 to an escutcheon plate 50 located on one side of the burner housing 42.

When working on the nozzle assembly 46 the technician must re-gap and re-adjust the electrodes tips 86 and oftentimes must properly reset the nozzle assembly 46 inside of the burner housing 42.

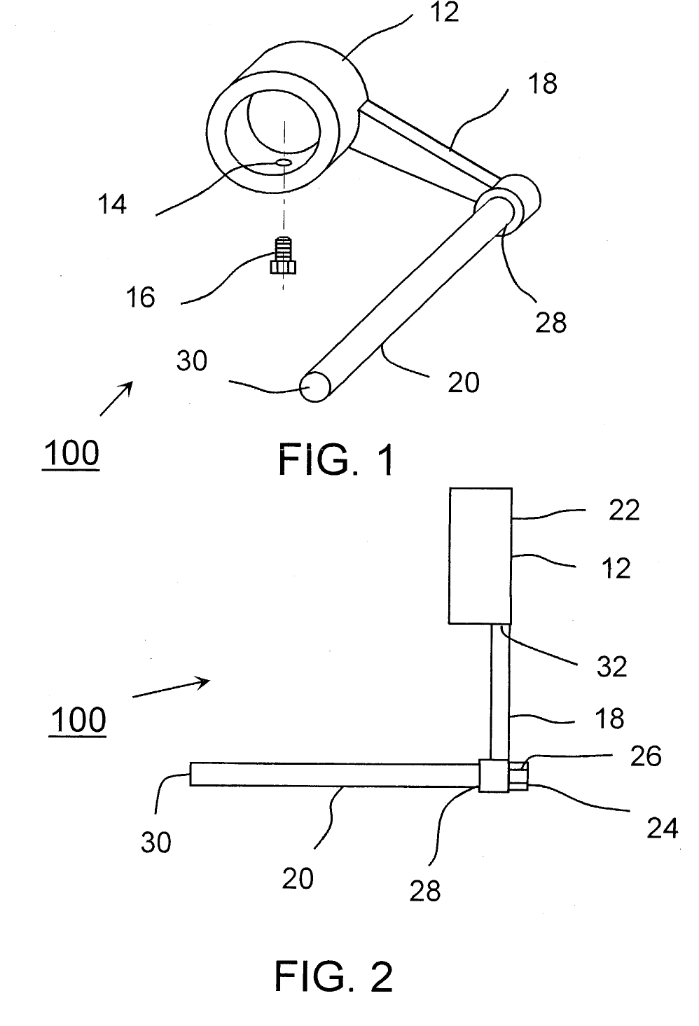

Referring now to FIGS. 1, 2 and 3 a nozzle assembly setting gauge 100 allows a technician to blindly reset the nozzle assembly 46 inside of the burner housing 42 with respect to the combustion head 44. An annular fitting 12 slides over the nozzle adapter 56 until its back surface 22 sets against a shoulder 60 of the nozzle adapter 56. The annular fitting 12 is tightened against the nozzle adapter 56 by a set screw 16 that is threaded through a female opening 14 of the annular fitting 12.

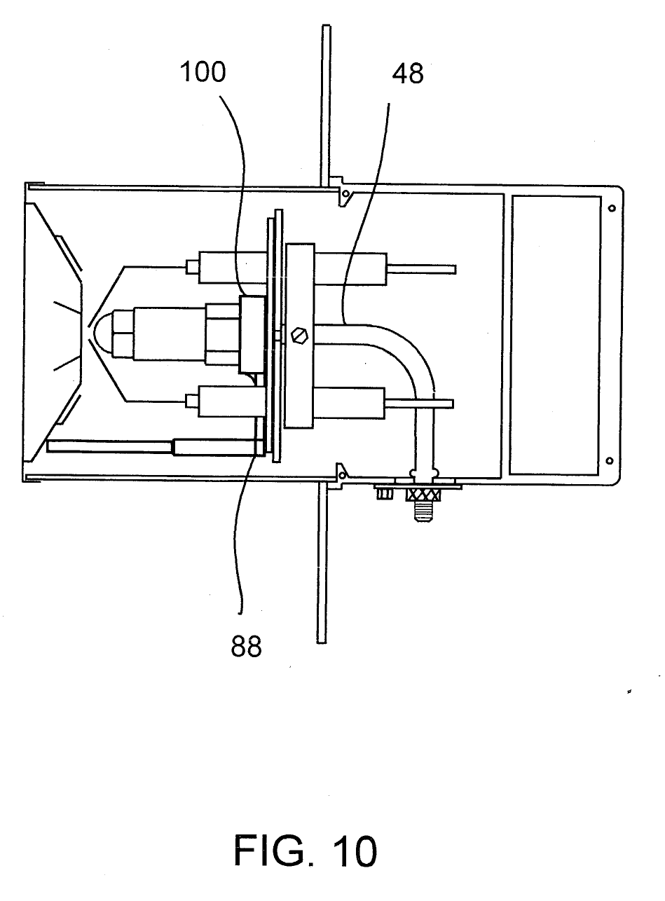

The nozzle assembly setting gauge 100 includes an extending member 18 that extends from an exterior surface 32 of the nozzle assembly setting gauge 100 which allows a frontward oriented setting post 20 to extend therefrom to the combustion head 44. The frontward oriented setting post 20 includes a threaded portion 26 that slides through an opening 28 in the extending member 18, or alternatively mates with a female threaded opening 88 in the extending member 18 shown in FIG. 10. A threaded nut 24 mates with the threaded portion 26 to secure the frontward oriented setting post 20 to the extending member 18.

To reset the nozzle assembly 46 so that the nozzle 58 is the proper distance from the combustion head 44, the technician merely slides the nozzle assembly 46 toward the combustion head 44 until he feels the setting post 20 come into contact with a backside 45 of the combustion head 44. At this point the nozzle assembly 46 is secured to the burner housing 42 via the escutcheon plate 50 which in turn is secured to the burner housing 42 via a set screw 43.

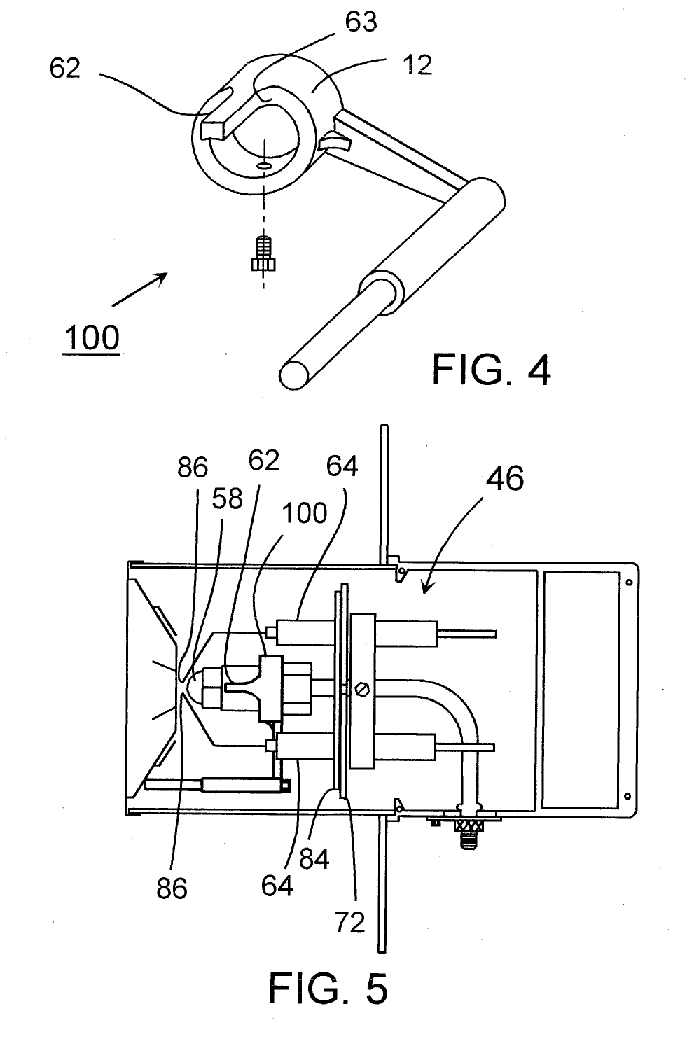

FIGS. 4, 5, 6 and 6A show another feature that can be added to the nozzle assembly setting gauge 100 to assist the technician in resetting the gap between the pair of electrode tips 86 and distance between the electrode tips 86 and the front and center of the nozzle 58. An electrode adjuster 62 disposed off of a front surface 63 of the annular fitting 12 is sized to define the proper distance between the tips 86 of the electrodes 64 and the proper distances between the electrode tips 86 and the front 55 and center 57 of the nozzle 58. Once the nozzle assembly 46 is removed from the burner housing 42, the nozzle assembly setting gauge 100 is slid forward to a pre-marked position, typically the front edge 77 of the nozzle adapter 56 and the front edge 79 of the annular fitting 12 align, so that the electrodes 46 can be properly adjusted. Then the nozzle assembly setting gauge 100 is returned back against the nozzle adapter shoulder 60 so that the nozzle assembly 46 can be properly reset inside of the burner housing 42.

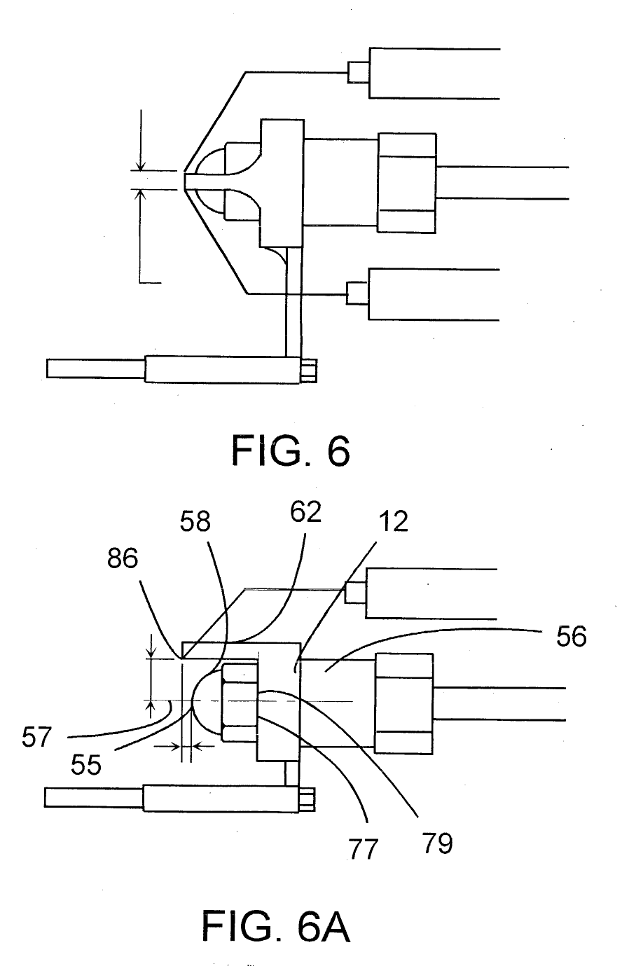

In FIG. 6A, there is shown how the electrode adjuster 62 provides the proper setting distance of the electrode tips 86 with respect to a centerline 57 of the nozzle 58 and with respect to the front 55 of the nozzle.

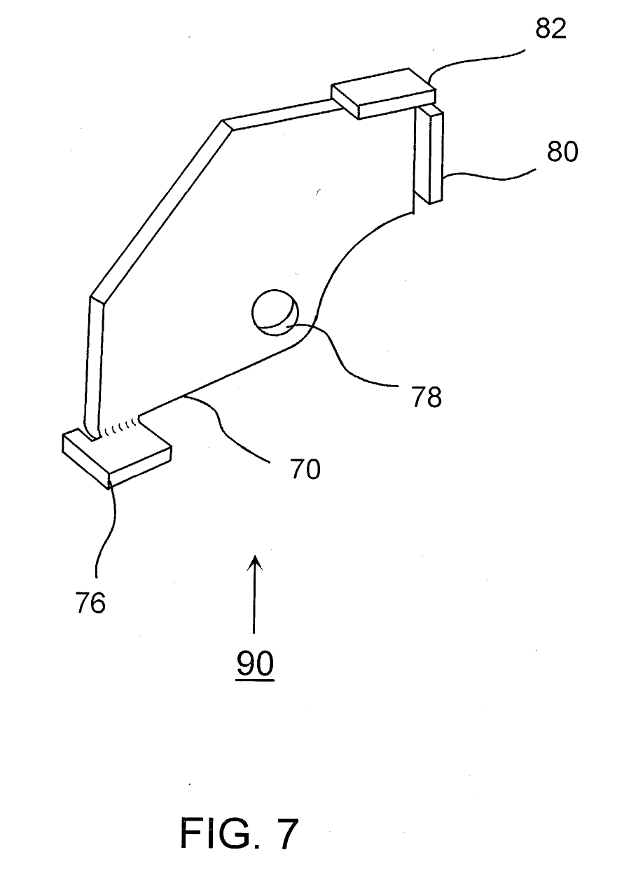

FIGS. 7, 8 and 9 show an electrode adjuster 90 that can be used in accordance with a nozzle assembly 46 that is secured to a combustion head 92 via a number of brackets 94. The electrode adjuster 90 is pivotally secured to a bracket via a screw 74. The electrode adjuster 90 includes a gap head 76 that defines the proper distance between the electrode pair (not shown) and when in the adjust position defines the proper distance between the front and center of the nozzle 58 and the electrode tips 86.

The electrode adjuster 90 is pivoted to an adjust position shown in FIG. 9 by rotating the electrode adjuster 90 until an axial set tab 80 and a radial set tab 82 contact a corner 96 of the bracket 94. Also, one tab only can be used.

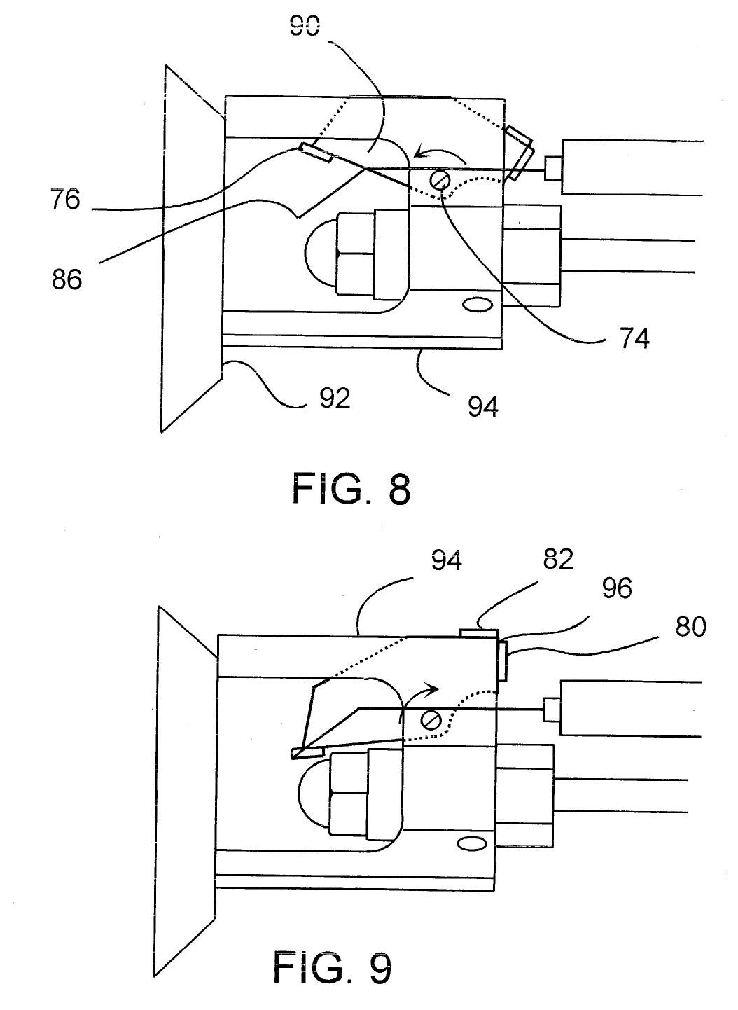

After adjusting the electrodes tips 86, the electrode adjuster 90 is returned to a non-adjust position as shown in FIG. 8. Radial set tab 82 prevents the adjuster 90 from falling to the adjust position and shorting the electrodes in case the screw 74 becomes loose. Loosening and tightening the screw 74 allows the technician to set and reset the electrode adjuster 90 between the adjust and non-adjust positions.

FIG. 10 shows how the nozzle assembly setting gauge 100 can be secured to various structures of the nozzle assembly. In FIG. 10, the nozzle assembly setting gauge 100 is secured to the nozzle assembly pipe 48 in a similar manner as described according to FIG. 3.

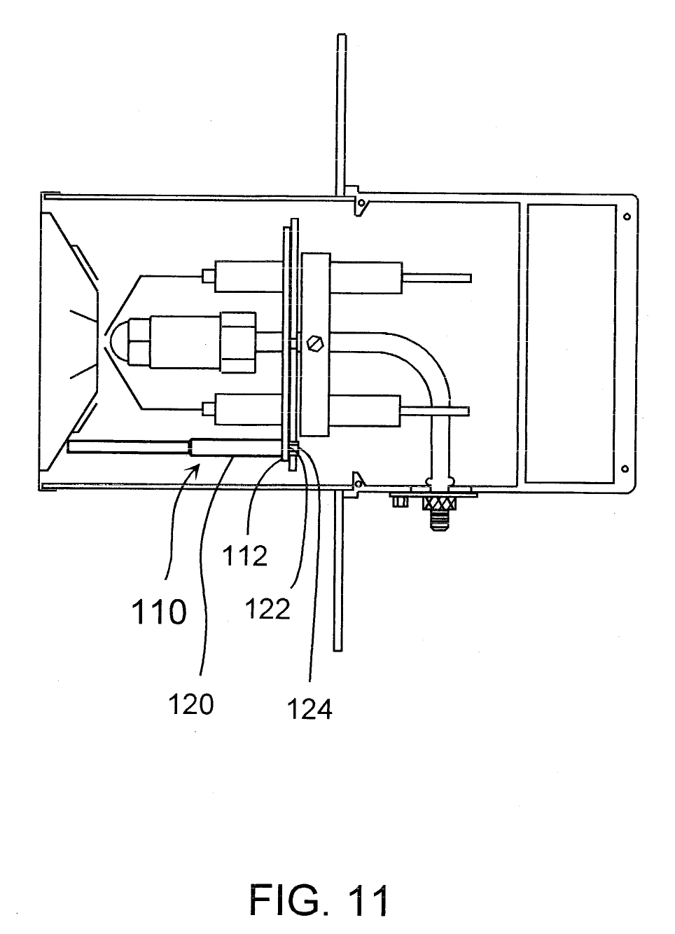

In FIGS. 11 and 12 a nozzle assembly setting gauge 110 is secured to a static plate 112 and to the nozzle assembly support 114, respectively. Rather than securing via the annular fitting 12, the setting post 120 is secured directly via a threaded portion 122 and a nut 124.

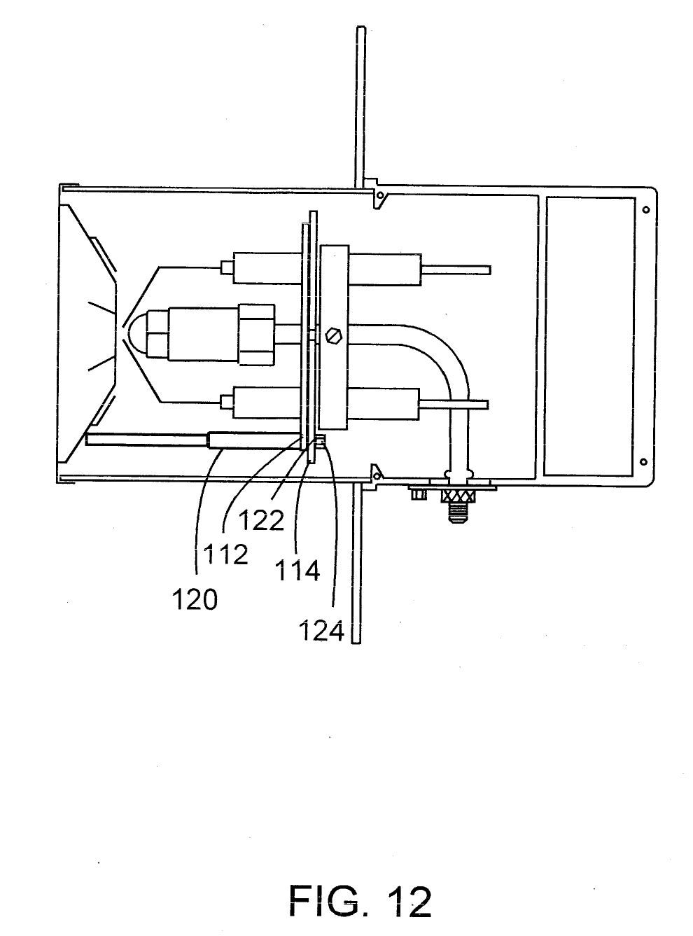

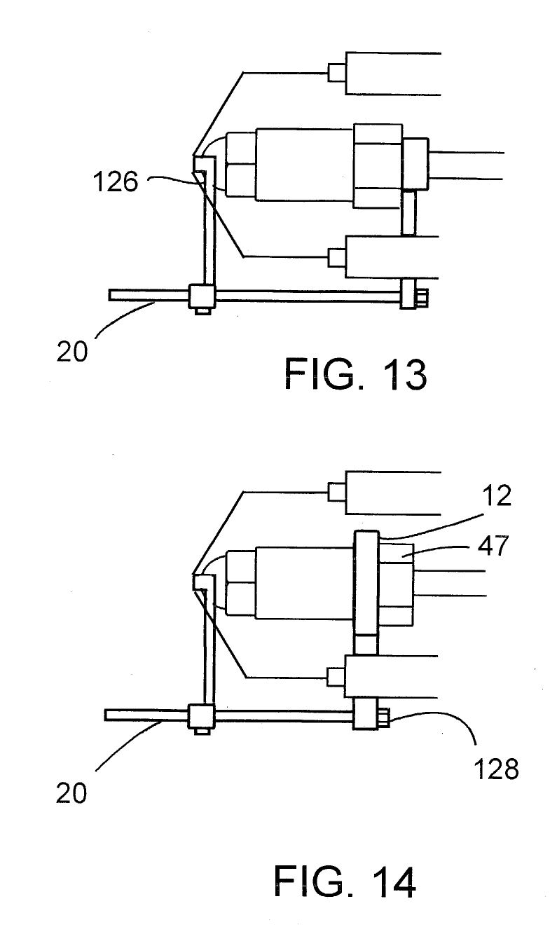

FIG. 13 shows how the setting post 20 includes an electrode adjuster 126 extending perpendicularly adjacent its contacting end. In FIG. 14, the annular fitting 12 is sized and shaped to fit over a nozzle adapter nut 47. The electrode adjuster 126 is swung away to a non-adjust position simply by loosening a securing nut 128, rotating the setting post 20, and re-tightening the securing nut 128.

FIG. 15 shows a nozzle adapter 56 having an extending member 18 extending directly from its exterior surface 49. The frontward oriented setting post 20 is fitted to the extending member 18 as previously described or as is otherwise apparent to one skilled in the art.

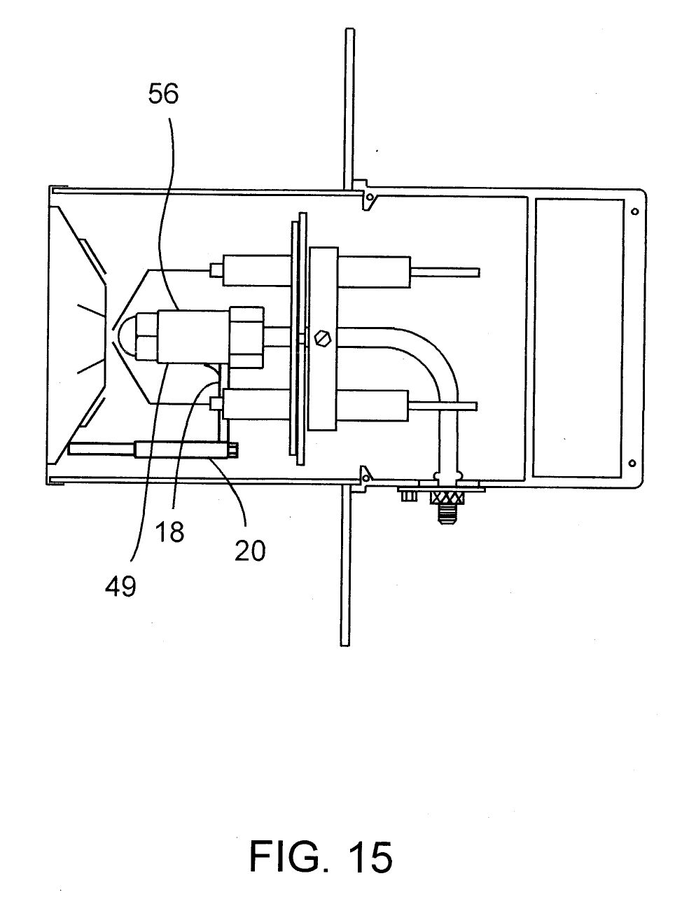

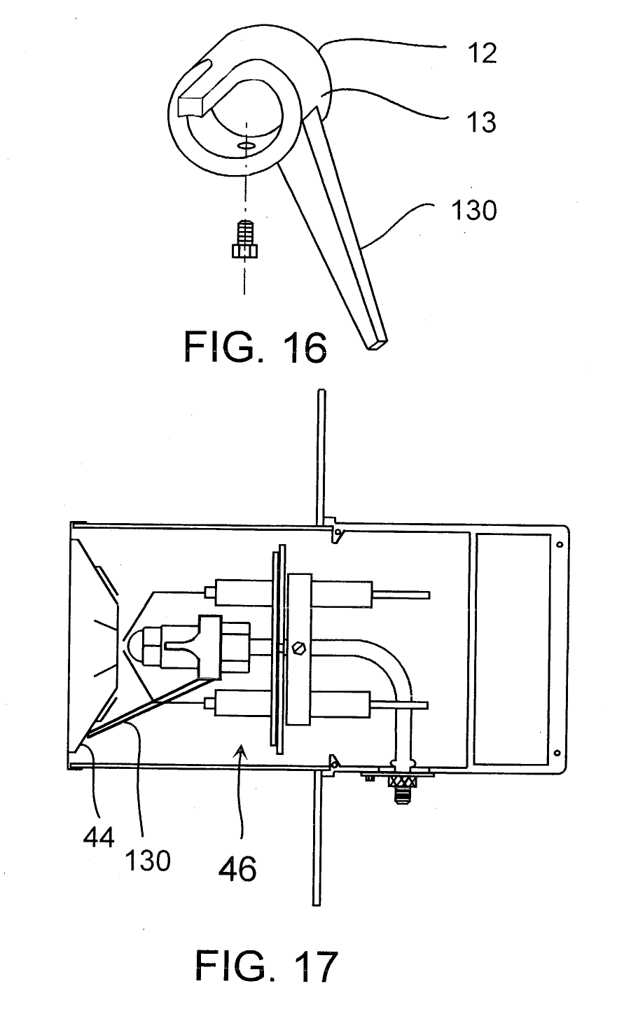

FIGS. 16 and 17 shows how an angled setting post 130 directly extends from the exterior surface 13 of the annular fitting 12. When resetting the nozzle assembly 46, the technician pushes the nozzle assembly 46 in until he feels the angled setting post 130 contact the combustion head 44.

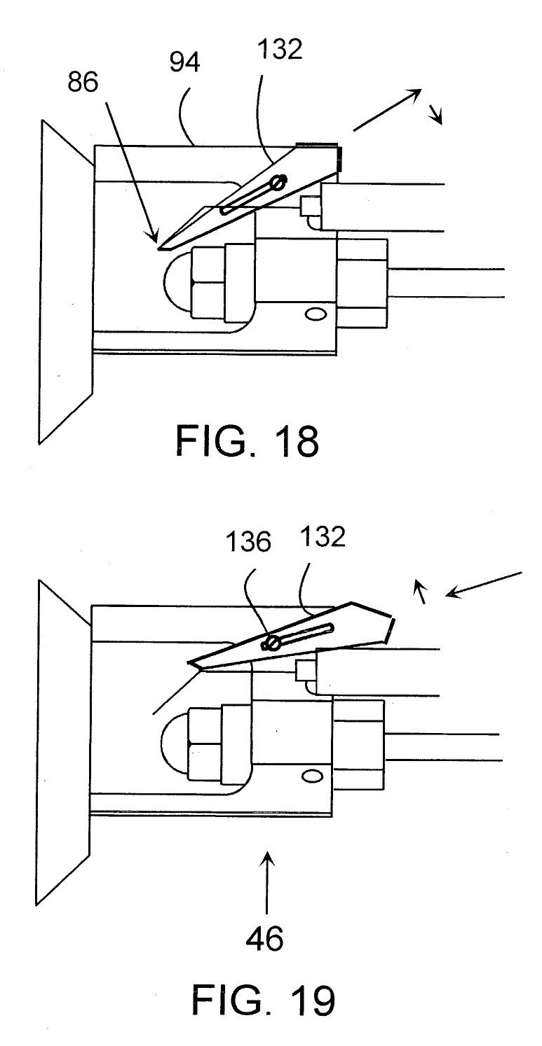

FIGS. 18 and 19 show a sliding electrode adjuster 132 that is secured to the bracket 94 of the nozzle assembly 46. A screw 136 is loosened and tightened to allow adjustment of the sliding electrode adjuster 132 between the adjust and non-adjust positions.

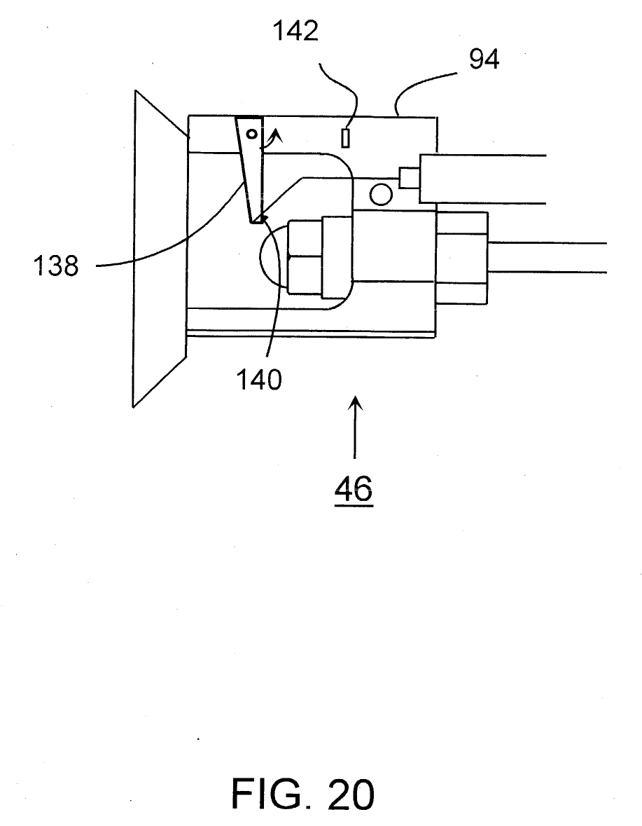

FIG. 20 shows a swing away electrode adjuster 138 secured to the bracket 94 of the nozzle assembly 46. The swing away electrode adjuster 138 includes a perpendicularly extending gapped portion 140 that is sized to define the gap between the electrodes 64 (only one of which is shown). The gapped portion 140 fits into an opening 142 disposed in the bracket 94 when the swing away electrode adjuster 138 is in the non-adjust position.

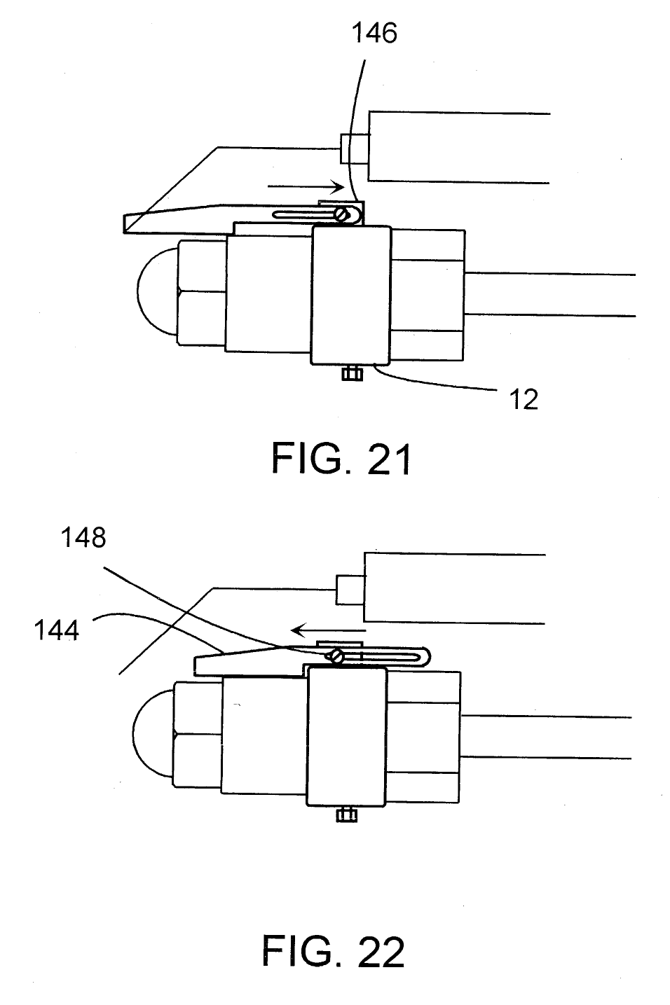

FIGS. 21 and 22 shows a sliding electrode adjuster 144 that is secured to a tab 146 extending directly from the annular fitting 12. A screw 148 is once again used to allow adjustment between the adjust and non-adjust positions.

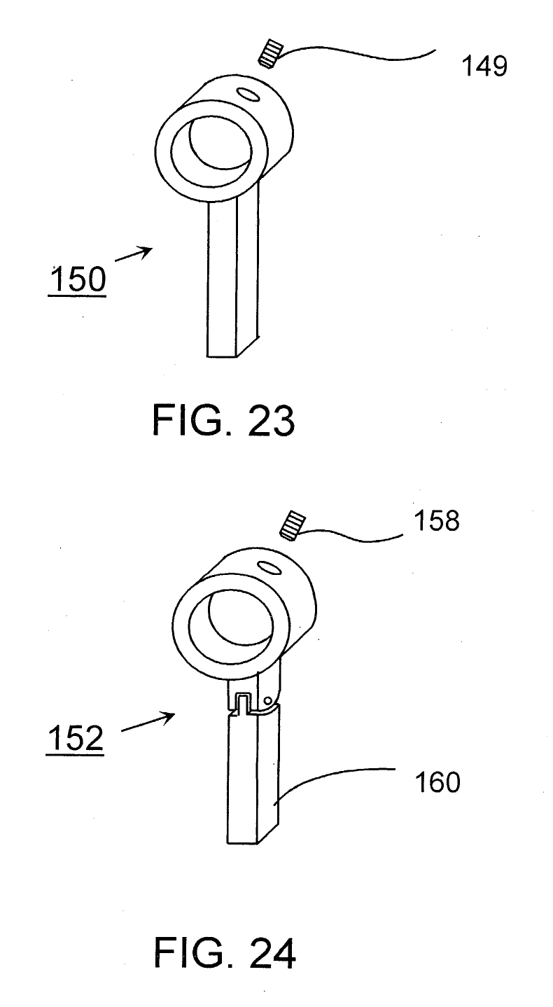

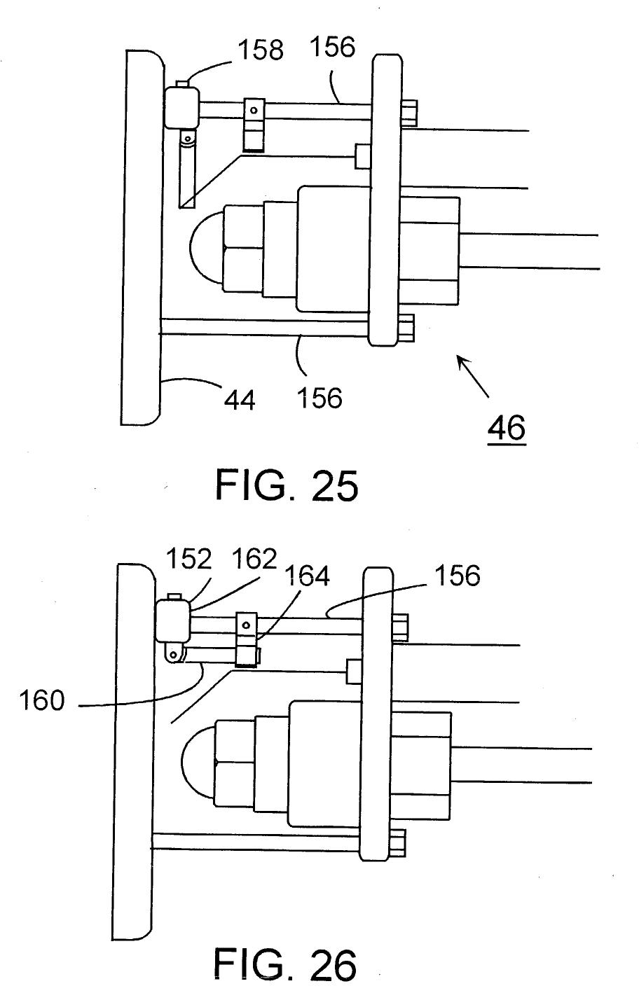

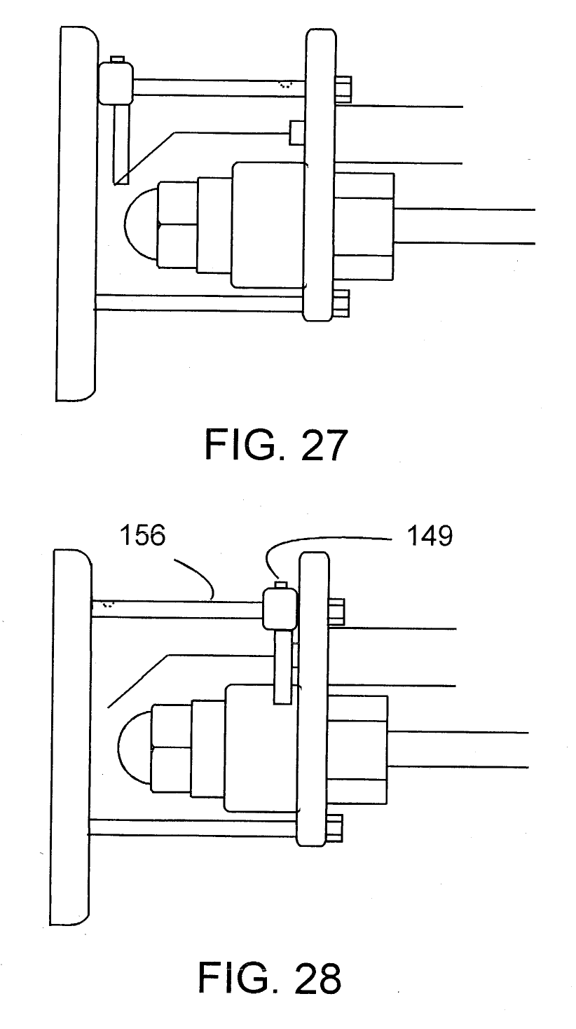

FIGS. 23 through 28 shows a sliding electrode adjuster 150 and a rotating swing away electrode adjuster 152 for use with a nozzle assembly 46 that is secured to a combustion head 44 via a plurality of posts 156.

The sliding electrode adjuster 150 is secured to a post by a set screw 149. For alternating the sliding electrode adjuster 150 between the adjust and non-adjust positions, the technician merely loosens the set screw 149 which allows him to slide the electrode adjuster 150 between the adjust and non-adjust positions.

The swing away electrode adjuster 152 is also secured to a post by the set screw 158. A swinging arm 160 rotates relative to an annular fitting 162. A clip 164 disposed on the post 156 secures the arm 160 in the non-adjust position.

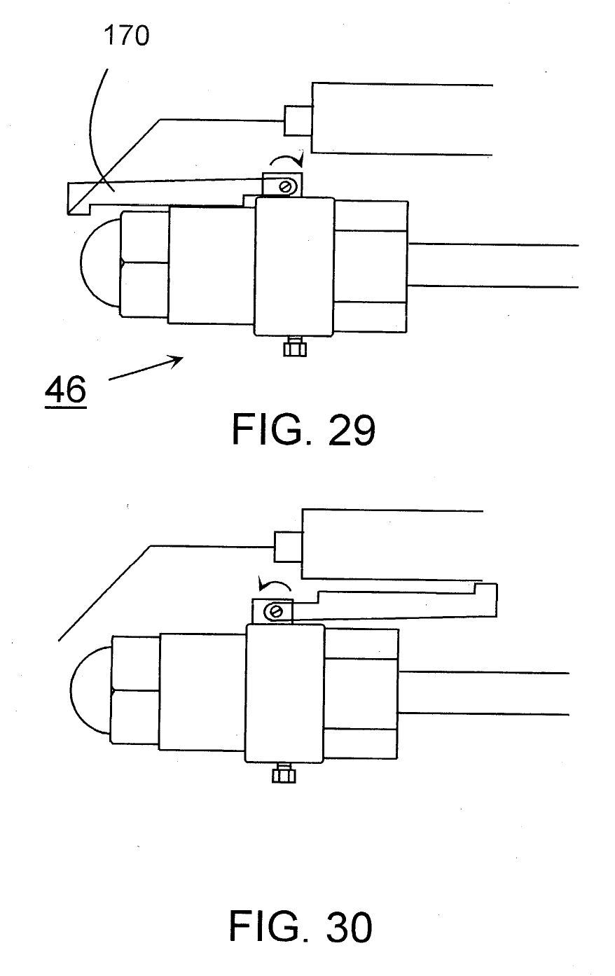

Referring now to FIGS. 29 and 30, there is depicted a swing away electrode adjuster 170 extending from the nozzle assembly 46.

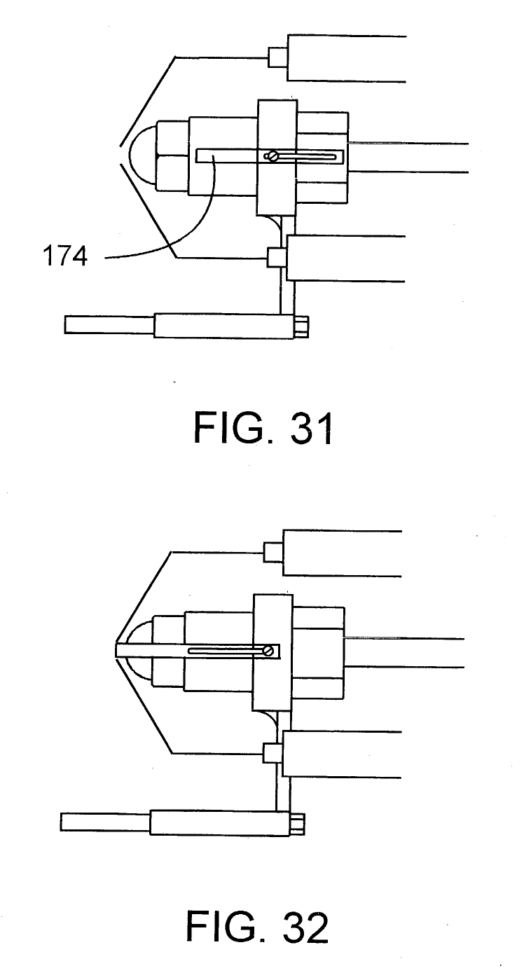

Referring now to FIGS. 31 and 32, there is depicted a sliding electrode adjuster 174 extending from the nozzle assembly setting gauge 100.

It should be understood that in each of the above non-limiting examples, the electrode adjuster can include a plurality of adjustment positions and adjustment marks to accommodate oil burners having different specifications.

Various changes and modifications, other than those described above in the preferred embodiment of the invention described herein will be apparent to those skilled in the art. While the invention has been described with respect to certain preferred embodiments and exemplifications, it is not intended to limit the scope of the invention thereby, but solely by the claims appended hereto.

What is claimed is:

1. A nozzle assembly setting gauge for determining the proper distance that a nozzle must be set from a combustion head in an oil burner, wherein a nozzle assembly includes a nozzle adapter for connecting a nozzle assembly pipe to the nozzle, wherein the nozzle adapter includes an exterior surface and a longitudinal axis, wherein said nozzle assembly setting gauge comprises:
a fitting having an interior surface sized and shaped to fit over an exterior surface of the nozzle adapter;
an extension member that extends from an exterior surface of said fitting; and
a setting post that extends frontward from said extension member toward the combustion head.

2. The nozzle assembly setting gauge of claim 1, wherein said fitting includes a female threaded opening and further including securing means for fixedly securing said fitting to said nozzle adapter.

3. The nozzle assembly setting gauge of claim 1, wherein said setting post includes a threaded portion that mates with a female threaded opening of said extension member.

4. The nozzle assembly setting gauge of claim 1, wherein said setting post includes a threaded portion that fits through an opening disposed through said extending member, and wherein a threaded nut mates with said threaded portion to secure said setting post to said extending member.

5. The nozzle assembly setting gauge of claim 1, wherein said nozzle assembly setting gauge is one piece.

6. The nozzle assembly setting gauge of claim 1, further including an electrode adjuster extending from said fitting.

7. The nozzle assembly setting gauge of claim 1, further including an electrode adjuster extending from said setting post.

8. The nozzle assembly setting gauge of claim 1, further including an electrode adjuster extending from said extension member.

9. An oil burner for use in an oil burning appliance, said burner comprising:
a burner housing;
an air tube adjacent to said burner housing;
a combustion head disposed at one end of an air tube;
a nozzle assembly including:
a nozzle assembly pipe which allows oil to flow from an oil source toward a combustion head;
a nozzle adapter connected to said nozzle assembly pipe, wherein the nozzle adapter includes an exterior surface and a longitudinal axis;
a nozzle connected to said nozzle adapter, said nozzle being disposed a predetermined distance from the combustion head;
a pair of electrodes each having an electrode tip; and
a nozzle assembly setting gauge affixed to said nozzle assembly, said nozzle assembly setting gauge further including a setting post that extends to contact said combustion head when said nozzle assembly is in a reset position.

10. The oil burner of claim 9, wherein said nozzle assembly setting gauge further includes a fitting having an interior surface sized and shaped to fit over the exterior surface of a portion of the nozzle assembly, and further including an extension member disposed between said fitting and said setting post.

11. The oil burner of claim 9, wherein said nozzle assembly setting gauge further includes a fitting having an interior surface sized and shaped to fit over the nozzle adapter, wherein said setting post extends angularly from said fitting.

12. The oil burner of claim 10, wherein said fitting includes a female threaded opening and further including securing means for fixedly securing said fitting to said nozzle adapter.

13. The oil burner of claim 10, wherein said setting post includes a threaded portion that mates with a female threaded opening of said extension member.

14. The oil burner of claim 10, wherein said setting post includes a threaded portion that fits through an opening disposed through said extending member, and wherein a threaded nut mates with said threaded portion to secure said setting post to said extending member.

15. The oil burner of claim 10, wherein said nozzle assembly setting gauge is one piece.

16. The oil burner of claim 10, further including an electrode adjuster extending from said fitting.

17. The oil burner of claim 10, further including an electrode adjuster extending from said setting post.

18. The oil burner of claim 10, further including an electrode adjuster extending from said extension member.

19. An oil burner for use in an oil burning appliance, said burner comprising:
a burner housing;
an air tube adjacent to said burner housing;
a nozzle assembly partially secured within said burner housing and partially disposed within said air tube:
a nozzle assembly pipe which allows oil to flow from an oil source toward a combustion head;
a nozzle adapter connected to said nozzle assembly pipe, wherein the nozzle adapter includes an exterior surface and a longitudinal axis;
a nozzle connected to said nozzle adapter, said nozzle being disposed a predetermined distance from the combustion head, said nozzle having a front, said nozzle further including a center line along its longitudinal axis;
a pair of electrodes each having an electrode tip;
a combustion head secured to said nozzle assembly, further including a securing means for securing said combustion head to said nozzle assembly; and
an electrode adjuster sized to define a proper setting distance between said electrode tips and the proper distance between the front of the nozzle and the electrode tips and the proper distance between the center line of the nozzle and the electrode tips.

20. The oil burner of claim 19, wherein said securing means includes at least one bracket, and wherein said electrode adjuster is secured to said at least one bracket.

21. The oil burner of claim 19, wherein said securing means includes at least one post, and wherein said electrode adjuster is secured to said at least one post.

22. The oil burner of claim 19, wherein said electrode adjuster includes a positioning means for allowing positioning between an adjust position and a non-adjust position.

23. The oil burner of claim 19, wherein said electrode adjuster is disposed from said combustion head.

24. The oil burner of claim 23, wherein said electrode adjuster includes a positioning means for allowing positioning between an adjust position and a non-adjust position.

25. An oil burner for use in an oil burning appliance, said burner comprising:
a burner housing;
an air tube adjacent to said burner housing;
a combustion head disposed at one end of an air tube;
a nozzle assembly including:
a nozzle assembly pipe which allows oil to flow from an oil source toward a combustion head;
a nozzle adapter connected to said nozzle assembly pipe, wherein the nozzle adapter includes an exterior surface and a longitudinal axis;
a nozzle connected to said nozzle adapter, said nozzle being disposed a predetermined distance from the combustion head;
a pair of electrodes each having an electrode tip; and
an electrode adjuster affixed to said nozzle assembly, said electrode adjuster including means for determining the proper distance between the electrode tips, and means for determining the proper placement of the electrode tips relative to the nozzle.

26. The oil burner of claim 25, wherein said electrode adjuster includes a positioning means for allowing positioning between an adjust position and a non-adjust position.
